(19) United States
(12) Patent Application Publication
(10) Pub. No.: US 2007/0259701 A1
(43) Pub. Date: Nov. 8, 2007

(54) Portable Electronic Apparatus With Detachable Audio Earpiece

(75) Inventor: Mark Mirvis, Brooklyn, NY (US)

Correspondence Address: EDWARD ETKIN, ESQ., Law Office of Edward Etkin, PC, 228 West End Avenue, Suite A, Brooklyn, NY, 11235, US

(73) Assignee: Time Piece Financial Services, Hewlett Harbor, NY (US)

(21) Appl. No.: 11/745,424

(22) Filed: May 7, 2007

Related U.S. Application Data
(60) Provisional application No. 60/798,668, filed on May 8, 2006.

(51) Int. Cl. H04M 1/00

(52) U.S. Cl. 455/575.2

(57) ABSTRACT

The present invention is directed to an audio-output capable portable electronic device (PED), such as a mobile telephone or a media player, having at least one integrated detachable earpiece, in one of a wireless, or a retractable wired configuration, that is stored at least partially within a storage cavity in the housing of the PED. In this manner, the detachable earpiece does not need to be carried separately from the PED and is always available when needed. In another inventive embodiment the detachable wireless earpiece is rechargeable, and the PED includes a recharger component connected to a power interface in the storage cavity in the PED housing, and also to the PED power sources such that when the rechargeable earpiece is placed into the storage cavity, it contacts the power interface and is recharged with energy from the PED power source. In yet another inventive embodiment, a novel case for storing a PED is provided, with the case having at least one integrated detachable wireless earpiece, stored at least partially within a storage cavity in the case, the earpiece being capable of wireless communication with the audio-output capable portable electronic device. Optionally, if the wireless earpiece is rechargeable, the case also includes the necessary components to recharge the earpiece when it is placed in the storage cavity. In an alternate inventive embodiment, the case may provide a substitute wireless link to the PED through the PED's conventional audio interface.

### CROSS REFERENCE TO RELATED APPLICATION

The present patent application claims priority from the commonly assigned U.S. Provisional Patent Application Ser. No. 60/798,668 entitled “MOBILE COMMUNICATION APPARATUS WITH DETACHABLE EARPIECE” filed May 6, 2006.

### FIELD OF THE INVENTION

The present invention relates generally to mobile communication devices, and more particularly to mobile communication devices capable of utilizing separate earpieces.

### BACKGROUND OF THE INVENTION

In recent years mobile communication devices, such as cellular telephones, smartphones, and communication-enabled PDAs, have taken the world by storm. Naturally, the popularity and prevalence of portable electronic devices (hereinafter “PEDs”) equipped with communication and/or audio output capabilities, has led to development of various accessories designed for use therewith. Such accessories range from simple practical items such as PED carrying cases and belt clips, to portable battery chargers, to headsets and earpieces with microphones that enable hands-free PED utilization.

In particular, headsets and earpieces have proven to be the most essential accessory for mobile communication-enabled PEDs (hereinafter “MCE-PEDs”) for a number of reasons. First, most MCE-PEDs are either very small and not comfortable to hold during use for extended periods of time, or bulky and uncomfortable to hold next to the ear (in case of certain PDA and smartphone PEDs). Second, MCE-PED users prefer to have their hands free during MCE_PED utilization. Finally, in many areas, local laws prohibit MCE_PED use by vehicle drivers unless the MOE_PED is used in handsfree mode.

There are a great many different available headsets and earpieces in all shapes, sizes and including various features such as integrated directional microphones, noise canceling, and even with capability of wirelessly linking with the MEA (for example, via Bluetooth or equivalent).

However, all previously known headset/earpiece devices (hereinafter “H/E devices”) suffer from one key disadvantage—being separate from the PED to which they must be connected, they represent yet another item that the PEED user is expected to carry along with the PED—a significant inconvenience, especially since the H/E devices don't fit into typical PED cases. In fact having a separate H/E device takes away from the utility and advantage of a sleek PED, such as a mobile telephone. Furthermore, in many cases, if the PED is carried separately from the H/E device, the user must locate the H/E device and plug it into the PED prior to use—often a frustrating task due to relatively small sizes of both items. Finally, the coiled wires of most H/E devices cause additional delays in initial deployment thereof.

It would thus be desirable to provide an audio-output capable portable electronic device having at least one integrated detachable earpiece, in one of wireless and retractable wired configurations, It would further be desirable to provide an audio-output capable portable electronic device having at least one integrated detachable wireless earpiece with a rechargeable power source that is recharged when the earpiece is returned to the device. It would also be desirable to provide a holding case for audio-output capable portable electronic device, the case having at least one integrated detachable wireless earpiece capable of wireless communication with the audio-output capable portable electronic device. It would additionally be desirable to provide a holding case for audio-output capable portable electronic device, the case having at least one integrated detachable wireless earpiece capable of wireless communication with the audio-output capable portable electronic device, and also being capable of recharging the detachable earpiece when it is stored therein.

### BRIEF DESCRIPTION OF THE DRAWINGS

In the drawings, wherein like reference characters denote corresponding or similar elements throughout the various figures:

FIG. 1 shows a diagram of a first exemplary embodiment of the inventive mobile communication device having an integrated detachable earpiece with a retractable wire; and

FIG. 2 shows a diagram of a second exemplary embodiment of the inventive mobile communication device having an integrated detachable wireless earpiece,

### SUMMARY OF THE INVENTION

The present invention provides an audio-output capable portable electronic device (PED), such as a mobile telephone or a media player, having at least one integrated detachable earpiece, in one of a wireless, or a retractable wired configuration, that is stored at least partially within a storage cavity in the housing of the device. In this manner, the earpiece does not need to be carried separately from the PED and is always available when needed.

In another embodiment of the present invention, the detachable wireless earpiece is rechargeable, and the PED includes a recharger component connected to a power interface in the storage cavity in the PED housing, and also to the PED power source, such that when the rechargeable earpiece is placed into the storage cavity, it contacts the power interface and is recharged with energy from the PED power source.

In yet another embodiment of the present invention, a novel case for storing the PED is provided, with the case having at least one integrated detachable wireless earpiece, stored at least partially within a storage cavity in the case, the earpiece being capable of wireless communication with the audio-output capable portable electronic device. Optionally, if the detachable earpiece is rechargeable, in an alternate embodiment of the present invention, the case includes an earpiece power interface in the storage cavity, that is connected to a recharger, and also connected to a power source inside the case (such as a battery), or to the power source in the PED, through the PED power interface (or equivalent). In an additional alternate embodiment if the PED is not equipped with a wireless communication link capable of communicating with the wireless earpiece, the case may include a wireless communication link connected to the audio interface of the PED (such as the headphone or earpiece jack), or an equivalent interface capable of transmitting audio (e.g. Universal Serial Bus (USB)).

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims,

### DETAILED DESCRIPTION OF THE PREFERRED EMBODIMENTS

The present invention provides an audio-output capable portable electronic device (PED), such as a mobile telephone or a media player, having at least one integrated detachable earpiece, in one of a wireless, or a retractable wired configuration, that is stored at least partially within a storage cavity in the housing of the device, and that may be recharged when placed therein. In this manner, the earpiece does not need to be carried separately from the PED, is always available when needed, and may receive needed power from the PED.

The apparatus of the present invention can advantageously be utilized in any form of audio output-capable PED ranging from a cellular/conventional/satellite/VoIP telephone, to a communication-enabled PDA, to a 2-way radio. The inventive apparatus can also be readily utilized with any portable electronic device (e.g., non-phone PDA, media player, etc.) where the user can receive audio data from the PED and/or transmit audio data thereto.

At the outset, it should be noted that the term “earpiece” as used herein is meant to refer to any form of miniature device capable of enabling the user to receive and hear audio data (and optionally to capture audio data, such as speech). Both in-ear and out-of-ear configurations are contemplated.

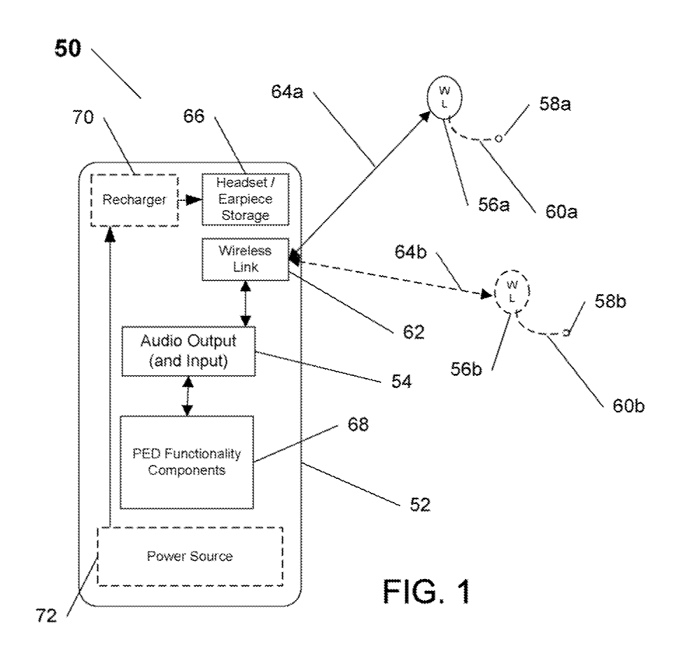

Referring now to FIG. 1, a first exemplary embodiment of the inventive apparatus is shown as PED 50. The PED 50 includes the PED body 52 (which is the PED itself), the PED functionality components 68 (which provide the main functionality of the device—i.e. PDA, phone, and/or media player functions and features), and a earpiece (or headset) storage cavity 66. The PED 52 also includes an audio output (and optionally input) component 54 that delivers audio from (and optionally to), the PED functionality components 68, and that is connected to a wireless link 62. The wireless link 62 is preferably capable of wireless audio communication with a remote earpiece and/or headset (e.g. through Bluetooth, wi-fi, wireless USB, or equivalent).

The apparatus 50 also includes an earpiece 56a, which may be supplied with an optional microphone 58a on a connector 60a (e.g. a tether, etc.), or which may have an integrated directional mike incorporated therein (not shown). The earpiece 56a, is supplied with a wireless communication link capability compatible with the wireless link 62, such that a wireless audio communication connection 64a may be readily formed therebetween, when the earpiece 56a is removed from storage 66 and the audio output and/or input features of the PED 52 are being utilized.

The earpiece 56a may be equipped with a long-life user-replaceable battery, or, optionally, it may have a rechargeable power source (not shown), and the storage 66 may include an earpiece 56a compatible power interface (not shown) connected to a recharger 70, which in turn draws power from a power source 72, such that the earpiece 56a is recharged during storage.

In an alternate embodiment of the present invention, the PED 50 may be provided with a second earpiece 56b, substantially similar to the earpiece 56a (with optional elements 58b and 60b similar to elements 58a and 60a), that may duplicate the audio output thereof, so that two users can simultaneously enjoy audio communication with the PED 52. In this inventive embodiment, the storage 66 is configured to be of sufficient size to store both earpieces 56a, 56b (and may optionally be equipped to recharge them as described above in connection with the earpiece 56a).

Optionally, the earpieces 56a and 56b may be configured to act as a stereo pair (i.e. one acting as the left earpiece and one acting as the right earpieces corresponding to the left and right stereo audio components) and each forming a corresponding wireless connection 64a, 64b to the wireless link 62, so that stereo audio may be received from the PED 52 and enjoyed by the user.

In an alternate embodiment of the invention, the above-described advantageous features of the PED 50 may be incorporated into a novel case for storing a PED (not shown), with the case having at least one integrated detachable wireless earpiece stored at least partially within a storage cavity in the case, the earpiece being capable of wireless communication with the audio-output capable PED. Optionally, if the detachable earpiece is rechargeable, in an alternate embodiment of the present invention, the case includes an earpiece power interface in the storage cavity, that is connected to a recharger, and also connected to a power source inside the case (such as a battery), or to the power source in the PED, through the PED power interface (or equivalent). In an additional alternate embodiment, if the PED is not equipped with a wireless communication link capable of communicating with the wireless earpiece, the case may include a wireless communication link connected to the audio interface of the PED (such as the headphone or earpiece jack), or an equivalent interface capable of transmitting audio (e.g., Universal Serial Bus (USB)).

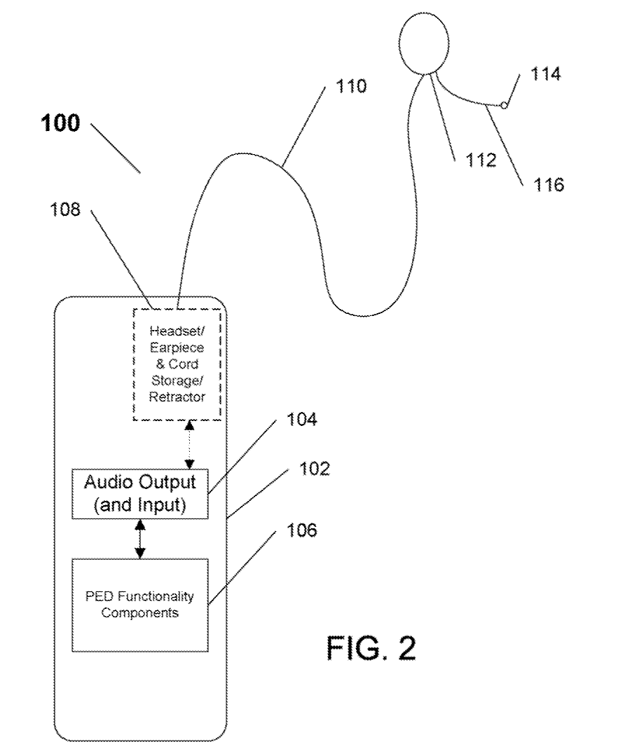

Referring now to FIG. 2, a second exemplary embodiment of the inventive apparatus is shown as PED 100. The PED 100 includes the PED body 102 (which is the PED itself), the PED functionality components 106 (which provide the main functionality of the device—i.e. PDA, phone, and/or media player functions and features), and a earpiece & wire storage/retractor 108. The PED 102 also includes an audio output (and optionally input) component 104 that delivers audio from (and optionally to), the PED functionality components 106.

The PED 102 further includes an earpiece 112, which may be supplied with an optional microphone 114 on a connector 116, or which may have an integrated directional mike incorporated therein (not shown), and which is connected to a wire 110, which is in turn connected to the wire storage/retractor 108 and to the audio output/input 104 to enable audio communication with the earpiece 112.

Preferably, the storage/retractor 108 is equipped with a spring-loaded extension and retraction mechanism that enables the earpiece 112 and wire 110 to be readily extended therefrom and then easily retracted when not in use. The storage/retractor 108 may be integrated into, an completely internal to the PED body 102, or it may be partially or entirely exposed, but still attached thereto.

In an alternate embodiment of the invention, the storage/retractor 108 may be detachable from the PED 102 so that it can be connected to different PEDs, or otherwise readily replaced. In this case, the wire 110 is supplied with a releasable connector (not shown) to the audio output/input 104. In yet another alternate embodiment of the PED 100, the storage/retractor 108 may be integrated into a carrying case/vehicle/and/or desktop holder for the PED 102 and the wire 110 configured such that when the PED is placed in the case/holder, the wire 110 is connected to the audio output/input 104, and use of the earpiece 112 is enabled.

For both exemplary embodiments of the present invention shown in FIGS. 1 and 2, the exact appearance, size, shape, and position of the respective earpieces, storage cavities (and retractor), and other PED components are selectable as a matter of design choice without departing from the invention.

Thus, while there have been shown and described and pointed out fundamental novel features of the invention as applied to preferred embodiments thereof it will be understood that various omissions and substitutions and changes in the form and details of the devices and methods illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. It is the intention, therefore, to be limited only as indicated by the scope of the claims appended hereto

I claim:

1. An apparatus for enabling at least partially handsfree utilization of a portable electronic device, comprising:
an earpiece for receiving audio data from the portable electronic device
a storage region defined at least partially within the portable electronic device, operable to store said earpiece; and
releasable means for releasably detaching said earpiece from said storage region to receive said audio data, and for selectively replacing said earpiece therein.

2. The apparatus of claim 1 further comprising a wire connecting said earpiece to the portable electronic device through said storage region, wherein said releasable means comprise a extension/retraction device positioned in said storage region and connected to said wire, operable to selectively extend and retract said wire and said earpiece.

3. The apparatus of claim 1, further comprising a first wireless link positioned in the portable electronic device, and a second wireless link positioned in said earpiece
